(19) United States
(12) Patent Application Publication
(10) Pub. No.: US 2021/0058651 A1
(43) Pub. Date: Feb. 25, 2021

(54) METHOD FOR DISTRIBUTING CONTENT

(71) Applicant: EASYBROADCAST, Saint Sebastien Sur Loire (FR)

(72) Inventors: Soufiane ROUIBIA, Nantes (FR); Imane MNIE-FILALI, Nantes (FR)

(73) Assignee: EASYBROADCAST, Saint Sebastien Sur Loire (FR)

(21) Appl. No.: 16/982,845

(22) PCT Filed: Mar. 13, 2019
(86) PCT No.: PCT/EP2019/056334

§ 371 Date: Sep. 21, 2020

(30) Foreign Application Priority Data
Mar. 19, 2018 (FR) 1852326

(51) Int. Cl. H04N 21/2385; H04N 21/234; H04N 21/239; H04L 29/08

(52) U.S. Cl. CPC H04N 21/2385; H04L 67/26; H04N 21/2393; H04N 21/234

(57) ABSTRACT

A method for distributing content from a content server in at least one private network including at least three terminals able to exchange data, the bandwidth with which at least one terminal is able to connect to the server being insufficient to allow the distribution of the content to each of the terminals via a connection of each to the server, the method including steps of: listing at least one of the terminals as master client and at least two other of the terminals as slave clients; transmitting at least one portion of the content to be distributed to this master client, especially via the connection to the content server; bringing the master client to push at least one portion of the content to be distributed to at least one of the slave clients of the private network via the links existing between the terminals within the private network.0

The present invention relates to a method for distributing content from a remote server to a plurality of terminals of a private network, some having limited bandwidth.

Some organizations, with various geographically distant sites, often have to distribute a video content to many terminals.

The need of each organization vis-à-vis the distribution of such a content may be different. It is for example a question of a message from a manager addressed to all his colleagues or of a promotional communication regarding a new product or service available in a bank branch or a store. It may also be a question of a personalized message intended for the guests of a hotel, of an administrative service broadcast or of an educational content, for example e-learning courses employed by a school or in various domains to enhance the skills of a company's employees.

These messages have no real-time constraint. If two users experience a difference of a second or more when viewing the same content, it is of no matter as long as the quality of the video is maintained and the user experience remains satisfactory.

Wide area networks or WANs are the most common type of network in such organizations. However, these networks are not always dedicated to the transport of multimedia content, this limiting their ability to provide a quality of service of professional level and a latency sufficient to guarantee a satisfactory experience to all end users.

In addition, the growth in the number of connected workstations within all the entities of an organization is continuously increasing the need for bandwidth, especially given the rapid expansion in the size of the video contents to be distributed.

Document WO 2008/038280 discloses a method for distributing media in real time over a public peer-to-peer network, in which certain peers not consuming content are used to retransmit the latter.

There is therefore a need to address the problem of distributing a content, in particular a multimedia content, from a remote server within at least one private network, and the invention aims to do this.

It achieves this aim by virtue of a method for distributing a content, especially a multimedia content, from a content server in at least one private network comprising at least three terminals able to exchange data with one another, the bandwidth with which at least one terminal is able to connect to the content server being insufficient to allow the distribution of the content to each of the terminals via a connection of each thereof to the content server, the method comprising steps of:

a) listing, especially in a management server (EB), at least one of said terminals as master client and at least two other of said terminals as slave clients,

b) transmitting at least one portion of the content to be distributed to this master client, especially via the connection to the content server,

c) bringing the master client to push at least one portion of the content to be distributed to at least one of the slave clients of the private network via the links existing between the terminals within the private network.

The method may also further comprise the step of:

d) at least one slave client that has not received the required packets of the content to be distributed from the master client receiving the missing packets from at least one other slave client using the links existing between the slave clients within the private network.

The invention makes it possible to maintain a fluid distribution of the content while keeping the initial network architecture of the organization. In the context of the invention, the terms “client” and “terminal” are synonymous. By public network, what must be understood is a broadband Internet network. The content server and/or the management server may be accessed over a public network, where appropriate.

The content may be distributed according to a first transmission protocol when the bandwidth is sufficient, and according to a second protocol when the bandwidth is insufficient for the first protocol to be implemented.

A management server is provided, to which the terminals of the private network are able to connect, before starting to receive the content distributed by the content server. This management server is able to determine, during the connection of a terminal thereto, with which protocol this terminal is to receive the distributed content.

To do this, the management server may perform a bandwidth test during the connection of the terminal, or, as a variant, deduce the bandwidth depending on the location of the terminal, on its IP address for example, using a database providing information on bandwidth as a function of location. Use of such a database is preferable because it is faster than performing a bandwidth test. The management server may be accessible by the terminals of the private network via a public network for example, or form part of the private network.

A terminal operating according to the first protocol may be configured to wait a predefined time to receive a packet from other terminals with which it is exchanging data before interrogating the content server. This time may for example depend on the size of the packets and on the number of slave and master clients.

The above second protocol is advantageously a distribution protocol with content pushed from the master client, in a format permitting the ability to make peer-to-peer exchanges between the slave terminals. At least some of the content to be distributed may be pushed by the master client to slave clients of the private network, these slave clients preferably being chosen at random by the master client.

At least some of the content to be distributed, between the slave clients, is advantageously distributed via a peer-to-peer distribution mechanism, in addition to reception of the packets pushed by the master client.

The method according to the invention may comprise the step of listing at least one of the slave clients of the private network as priority-slave client, and of bringing the master client to prioritize pushing the packets of the content to be distributed to this priority-slave client. The packets may be pushed to the other slave clients by choosing them at random.

By “push” what must be understood is a distribution mode in which the receiver of the packets receives the latter without having requested them to be sent, once it has made itself known to the sender.

Each packet, also called a chunk, may be a video packet having a size comprised between 256 kB and 2.56 MB, and for example of 1 M.

The method may also comprise the step of bringing the slave clients of the private network, other than the priority-slave client, to address themselves to the priority-slave client to receive the packets of the content to be distributed in case of failure of the master client.

The method may comprise the step of listing as master client the first terminal of the private network to connect to the management server with a view to requesting reception of the content to be distributed. Preferably, however, the management server checks that the bandwidth available to this terminal is sufficient to receive the video packets according to the first protocol from the remote server, before listing it as master client.

The method may comprise the step of listing as priority-slave client the second terminal of the private network to connect to the management server with a view to requesting reception of the content to be distributed.

At least one piece of information regarding the location of the terminals within the private network may be listed in the management server and this piece of information may be used to decide, for each terminal, the assignment of the addresses of the other terminals to be interrogated by this terminal to receive packets of the content.

At least one piece of information regarding the resources available to the terminals within the private network may be listed in the management server and this piece of information may be used to decide the assignment of a profile to a terminal connecting to the management server, and especially to decide whether this terminal must become master client, priority-slave client or slave client.

The management server may thus transmit to a terminal of the private network information relating to the information-exchange protocol to implement with the other clients of the private network to retrieve the packets of the content to be distributed and/or to distribute them.

The management server may be arranged to verify, during the connection of a terminal to the management server, whether this terminal has available to it resources that are greater than that of the master client with which it is intended to exchange to receive the packets of the content. By “resources that are greater” what must be understood is that, because of bandwidth and/or hardware performance, this terminal will be able to play the role of master client in a way that is more beneficial to the other slave clients that will receive their packets therefrom, than the current master client. If this is so, the management server may be arranged to list this terminal as new master client instead of the old one, and to tell this old master client that it no longer has this status. The management server may switch the status of the old master client to priority-slave client or to slave client, depending on the resources available to it and those of other clients of the swarm. By “swarm” what is meant is all the clients that exchange data with one another to receive packets of a given content.

Thus, the method may comprise the step of determining, during a connection to the management server of a terminal of the private network, whether this terminal is able to access directly, because of the available bandwidth, the packets of the content to be distributed, and if so bringing this terminal to receive said packets from the content server directly or via a peer-to-peer connection with other terminals and not to receive pushed packets.

It may be advantageous for at least one slave client or one priority-slave client to be shared between two swarms. The choice of the shared client is made by the management server preferably depending on the amount of progress in the download of each of the two swarms, at least one slave or priority-slave client preferably being chosen among that of the two swarms that has progressed most in its download.

This may allow, when one swarm has progressed further with downloading than another swarm, the clients of this other swarm to retrieve the packets of the content more easily.

In one exemplary implementation, only one slave or priority-slave client is shared between two swarms. This shared client may be chosen depending on the time lag between the downloads of the content, and may in particular be chosen from the clients of a swarm that has progressed further with the download compared to the clients of the other swarm.

A master client may be arranged to wait a predefined time to receive a packet of the content from the other terminals, and especially master clients, with which it is exchanging data, before contacting the content server to obtain this packet.

In the presence of one or more terminals having a sufficient bandwidth to receive the packets directly from the content server and to exchange packets with at least one master client, but exchanging packets with no slave clients, the one or more master clients may be arranged to prioritize seeking to receive the packets of the content from one or more of these terminals that have progressed most in the download of the content. If the packets cannot be obtained from these terminals within a predefined time, then the master client may contact the content server.

The management server may be dedicated to a plurality of separate private networks.

The private network for example comprises between 3 and 10 000 terminals, and better still between 10 and 10 000 terminals.

The number of slave terminals to which content is pushed by a master client is for example comprised between 2 and 50.

The content to be distributed is for example a video content, especially a slightly differed or live filmed event.

Another subject of the invention is also a computer-program product, especially for implementing the method according to the invention as defined above, comprising, on a computer medium or a medium to be downloaded, a set of instructions that are readable by a management server, these instructions bringing during the execution of the program the management server to:
on reception of a request originating from a first terminal of at least one private network, the bandwidth with which this first terminal is able to connect to a content server being sufficient to allow the content to be distributed to this first terminal via a direct connection thereof to the content server, list this terminal as master client and bring this terminal to receive the content to be distributed, in particular via its connection to the content server,
bring this first terminal to push at least one portion of the received packets of the content to be distributed, to at least one other terminal of the private network,
on reception of a request originating from another terminal of the private network, the bandwidth with which this other terminal is able to connect to the content server being insufficient to allow the content to be distributed to this other terminal, list this terminal as slave client and bring this terminal to receive the content to be distributed from the master client and/or from at least one other slave terminal of the private network via exchanges of data within the private network.

The invention will possibly be better understood on reading the detailed description that follows, of a non-limiting example of implementation of the invention, and on examining the appended drawing, in which:

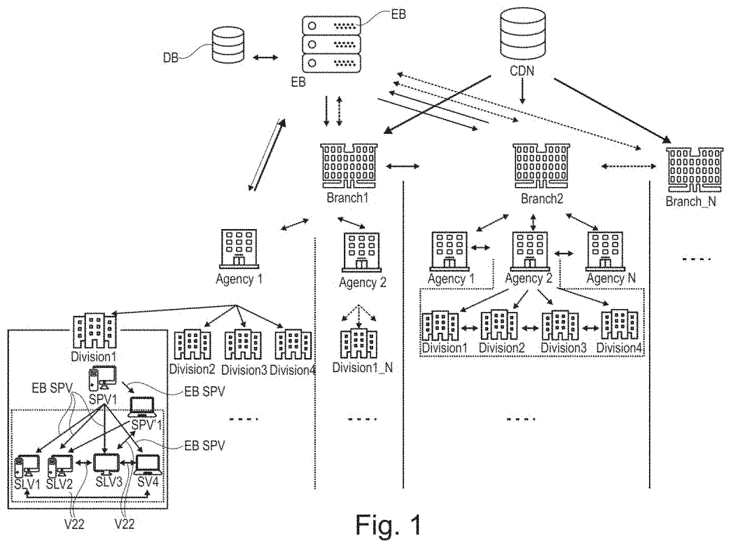

FIG. 1 illustrates the links that may exist between various entities of an organization, a remote content server and a management server,

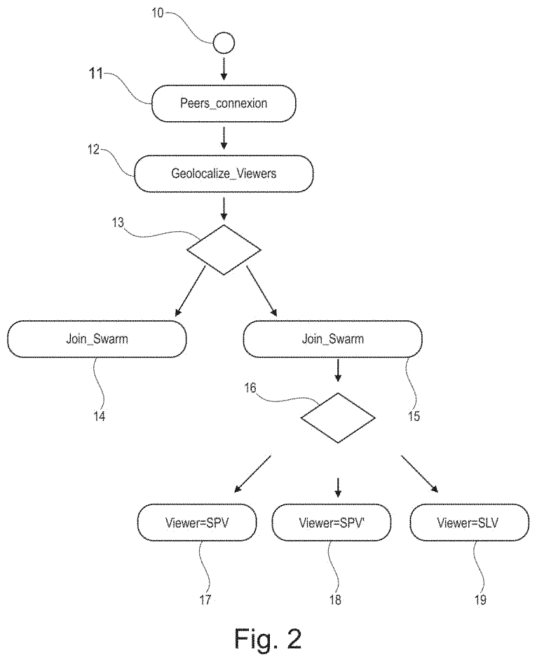

FIG. 2 gives an example of assignment of client profiles, to users connecting to the management server,

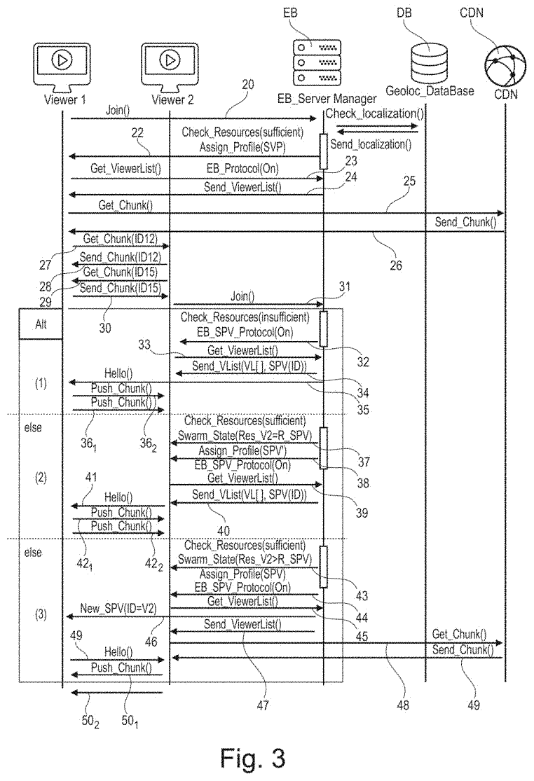

FIG. 3 illustrates an example of data exchanges between two terminals of the private network, the remote content server and the management server, and

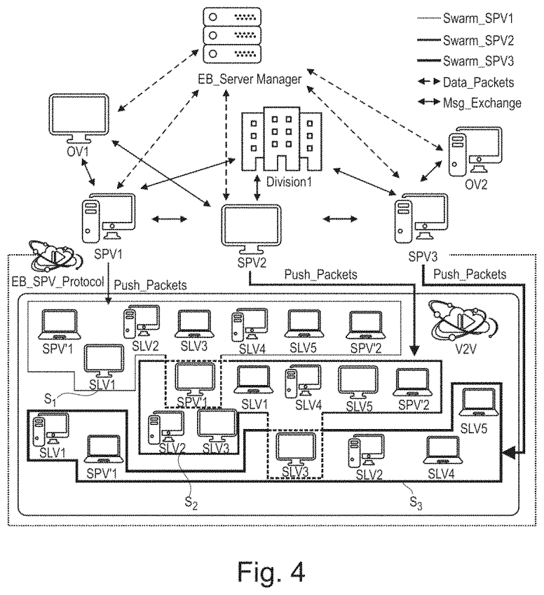

FIG. 4 illustrates the implementation of different distribution protocols within a given entity.

FIG. 1 shows an example of an organization comprising a plurality of entities seeking to receive content distributed by a content server CDN, which is also referred to as the content source or remote server.

A management server EB is provided to ensure the implementation of the invention.

In the example in question, the content server CDN is able to communicate with N branches of the organization, each containing several agencies, which may themselves be broken down into a plurality of divisions.

Each of the branches for example contains more than 1000 terminals (also referred to as workstations) and communicates with the server CDN via a high-speed link, for example of a public network, while some agencies communicate with their divisions via a private network the link of which is of low-speed, 2.5 or 3 MB/s for example. Each agency contains, for example, between 10 and 30 terminals. FIG. 1 shows a “divisionl” containing six terminals. The number of terminals is given merely by way of illustration and the invention applies to any type of organization regardless of the number of terminals and the distribution of the latter within the organization.

Each branch may retrieve the multimedia content to be distributed from the server CDN.

The private networks of the various branches are able to communicate with one another, for example via the public network, via a high-speed link.

The management server EB is for example external to the private networks of the organization (as illustrated) and is able to communicate with them via the public network.

Each terminal of the organization is able to connect to the management server EB, using its internet browser.

To receive the content distributed by the server CDN, the terminals first connect to the management server EB, which decides on the protocol to implement for a terminal to receive the video packets of the content distributed by the server CDN.

This protocol is chosen depending on the resources, in particular the bandwidth, available to this terminal.

Depending on the availability of bandwidth, one of two different transmission protocols, called EB_Protocol (also referred to as V2V) and EB_SPV_Protocol below, is implemented.

The V2V exchange protocol is implemented to facilitate the reception of packets by the branches and relieve the server CDN. This V2V exchange protocol is of the peer-to-peer type and preferably complies with the teaching of patent application EP 3 156 920 A1 in the name of the applicant. It consists in serving the content to at least one client in client/server mode, in a format allowing its subsequent distribution in P2P mode.

The management server EB selects, for each user, among all those watching the same content, the best list of users, i.e. those users that will be able to retrieve the content with the best quality of service. This list is established on the basis of a number of parameters including geolocation, connection quality and connection network, machine and browser used, inter alia. As, unlike the live broadcast of television channels, there is no real real-time constraint, the protocol policy with respect to retrieval of video packets is much more oriented towards retrieval between users with higher waiting times.

The protocol EB_SPV_Protocol is implemented to take into account the low available bandwidth and allows some of the content to be distributed in pushed mode from a master terminal to one or more slave terminals, in a format allowing them to be exchanged in P2P mode between slave terminals.

The management server EB is arranged to determine with which protocol each terminal of the organization may or must operate.

Several techniques, including measurement of the bandwidth of the client on his connection, may be used for this purpose. If the bandwidth is sufficient, the management server brings this client to operate according to the protocol V2V.

Another preferred method is the geolocation of the client, as will now be described with reference to FIG. 2.

In this figure, step 11 “Peers_connexion” corresponds to the connection of a client, for example after the start 10 of the distribution of the content by the server CDN.

In step 12 “Geolocalize_Viewers”, the client is located, by virtue of its IP address. By querying a database DB (schematically shown in FIG. 1), the management server EB is able to learn, in step 13, whether the client is or is not located in a region with sufficient bandwidth, and to compare the resources available to the terminals, so as to preferentially select, for the role of master client, clients with the best resources.

If the bandwidth is sufficient, this corresponding to step 14 “Join_swarm”, the terminal in question may join the swarm and receive the packets via the protocol V2V.

If the bandwidth is insufficient, this corresponding to step 15 “Join_swarm”, then, depending on the number of terminals of the same private network that have already connected to the management server EB, the management server EB determines, in step 16, the profile of the terminal, in the context of the implementation of the protocol EB_SPV_Protocol.

When the terminal is alone, i.e. the swarm contains only one terminal, it is assigned the profile of master client SPV in step 17 “viewer=SPV”.

In the presence of only one other already connected terminal, which terminal is therefore the master client, i.e. when the size of the swarm is equal to two, this terminal is assigned, in step 18, the profile of a priority-slave client “Viewer=SPV′”, unless it has better resources.

In the presence of more than two other already connected terminals, i.e. a master client and a priority-slave client, this terminal is assigned the profile of a slave client in step 19 “Viewer=SLV”, unless it has better resources.

The number of master clients and priority-slave clients may vary depending on the size of the network.

An example of data exchanges between two terminals Viewer1 and Viewer2 of the private network, the management server EB, the database DB, and the content server CDN will now be described in more detail, with reference to FIG. 3.

Step 20 corresponds to a connection request “Join( )” addressed by the terminal Viewer1 to the management server EB “EB_Server_Manager”.

The server EB interrogates, in step 21, the database DB “geoloc_Database”, this corresponding to the exchanges “Check localization( )” and “Send_Localization( )”, and determines, in light of the IP address or another identifier of the client, whether, given the location of the user, the bandwidth is sufficient.

If the bandwidth is sufficient “Check_Resources (sufficient)”, the management server EB informs the user of this in step 22, and in this example assigns it the profile of master client SPV “Assign_Profile (SPV)” and informs it that it will implement the protocol V2V “EB_Protocol (on)”.

The user Viewer1 responds by asking, in step 23 “Get_Viewer_List( )”, the management server EB for a list of users with which it will be able to exchange data.

The user Viewer1 obtains in response from the management server EB, in step 24, the list of users with which it may exchange content packets using the V2V “Send_Viewer_list( )” protocol.

The user Viewer1 then operates in V2V mode (“EB_Protocol”). This includes obtaining, in step 25, packets from the content server CDN “Get_Chunk( )”, receiving them in step 26 “Send_chunk( )”, and also obtaining packets from other master-client users in particular.

To do this, each master client will wait a predefined time to receive a missing chunk from the other master clients, and, if it does not, it will download it directly from the content server.

By way of illustration, step 27 corresponds to a request to obtain a missing packet from one of the users of the list communicated in step 23, namely the user Viewer2 in FIG. 3. The corresponding packet is communicated in step 28. The user Viewer1 may also transmit the list of missing packets to other clients, this having been illustrated by steps 29 and 30. Step 29 corresponds to a request by the terminal Viewer2 for a packet to the terminal Viewer1 (Get_Chunk (ID15) request) and step 30 corresponds to the transmission by the terminal Viewer1 of this packet (Send_Chunk (ID15)).

If the bandwidth available to the terminal Viewer2 is insufficient for a satisfactory implementation of the above protocol V2V, then the management server EB requires the content to be distributed according to the protocol EB_SPV_Protocol, and informs the terminal Viewer 2 of this via the message 32 (“EB_SPV_Protocol (On)”). This protocol requires there to be at least one “master” terminal (also called a super viewer or SPV) able to play the role of internal server vis-à-vis one or more slave terminals (also called slave viewers or SLV). In the illustrated example, it is a question of the terminal Viewer1. Its role will be to push the received video packets to the other terminals of its swarm. This master terminal is here assumed to already exist on the connection of the client Viewer2 in step 31 to the management server EB.

In step 33, the user Viewer2 requests “Get_Viewer_list( )” the list of users making up the swarm from the management server EB and obtains it in step 34 “Send_Vlist (VL [ ], SPV (ID))”. This list also contains the address of the master client.

The management server warns, in step 35, the master client Viewer1 “Hello( )”. Next, the master client pushes “Push_Chunk( )” the packets, in steps 36₁, 36₂, . . . , to the terminal Viewer2, as they become available and are able to be received by this slave client Viewer2.

If, during the connection request of the terminal Viewer2 in step 31, the management server EB determines that there are sufficient resources and in particular bandwidth, it informs the terminal Viewer2 of the state of the swarm in step 37 and assigns thereto a profile in step 38, in the present case that of priority-slave client SPV′ “Assign_Profile (SPV)”, and indicates thereto that the distribution protocol is the protocol EB_SPV_Protocol “EB_SPV_Protocol (on)”.

It is assumed here that the resources of the terminal Viewer2 are no better than those of the master client Viewer1 “Swarm_state (Res_V2=R_SPV)”.

The terminal Viewer2 then asks the management server EB, in step 39, for the list of users, which it obtains in step 40.

Next, the terminal Viewer2 may make itself known to the master client in step 41, and obtains, in steps 42₁, 42₁, . . . , the content packets (“chunks”), delivered in push mode by the terminal Viewer1.

If, following the connection in step 31, the management server EB determines that the resources of the terminal Viewer1 are better than those of an existing master client “Swarm_state (Res_V2>R_SPV)”, in the present case Viewer1, then the management server EB assigns, in step 43, to the terminal Viewer2, the profile of a master client SPV “Assign_Profile (SPV)” and launches the protocol EB_SPV_Protocol in step 44 “EB_SPV_Protocol (on)”.

The master client Viewer2 then asks the management server EB in step 45 for the list of users “Get_Viewer_list( )”.

The management server EB informs, in step 46, the terminal Viewer1 that it has ceased to be master client and that the new master client is the terminal Viewer2 “New_SPV (ID=V2)”.

The management server EB then sends, in step 47, to the terminal Viewer2, the list of clients of the swarm “Send_Viewer_List( )”.

The terminal Viewer2 requests, from the content server, in step 48, packets of the content, which it obtains in step 49.

Next, the terminal Viewer1 makes itself known, in step 49, to the master client Viewer2 and may receive in push mode the packets of the content in steps 50₁, 50₂, . . . .

The library with the various protocols (V2V protocol and EB_SPV_Protocol) may be in Javascript and retrieved by the browser of the terminal when it connects to the web page with a view to downloading the stream, i.e. to the page of the management server EB. The protocol and the profile of the user are chosen after the first exchange with the management server EB. The profile of the terminal and the protocol used may change during viewing of the content, depending on the instructions of the management server EB.

Depending on the chosen rules, the one or more master terminals SPV may be chosen, by the management server EB, depending on the order of connection to the network, as illustrated in FIG. 2, or depending on the resources thereof, as described with reference to FIG. 3.

The content may, where appropriate, be distributed to a plurality of slave terminals via a plurality of master terminals SVP, depending on various parameters such as bandwidth, network size, the way in which the content is encoded, inter alia.

Once the one or more master terminals SPV have been designated, the profile of slave terminal SLV is assigned to all the terminals of its swarm.

One of these slave terminals may nevertheless be assigned a client profile of priority slave SPV′ and be prioritized to receive more video packets from the master client SPV than the other slave clients, so as to provide a back-up solution with a view to replacing the master terminal SPV should it “crash” or be disconnected, thus ensuring the continuity of the distribution and preventing the video from freezing on the other slave terminals SLV.

FIG. 1 shows the private network corresponding to “divisionl”, this network being formed by a master terminal SPV1 that receives its packets from the server CDN via the protocol V2V.

It sends the packets using the protocol EB_SPV_Protocol to a priority-slave client SPV′1, and to four other slave clients SLV1 to SLV4, this being indicated by the EB SPV arrows. Between the terminals SLV1 to SLV4 and SPV′1, an exchange using the protocol V2V may take place, this being indicated by the V2V arrows.

Depending on the size of the network and the available bandwidth, a network may require several priority-slave terminals SPV′ to be present.

An example of the implementation of the various protocols and of the distribution of profiles within a given entity is illustrated in FIG. 4.

Within a given division, the master terminals SPV may exchange packets with one another using the protocol V2V, as illustrated by the V2V arrows for the clients SPV1 to SPV3.

The master terminal SPV1 operates according to the EB_SPV_Protocol protocol vis-à-vis slave terminals SLV1 to SLV5 and SPV′1 and SPV′2 and thus pushes (“Push_packets”) the video-content packets to these slave terminals.

Likewise, the master terminal SPV2 pushes (“Push_packets”) the packets to a set of terminals comprising five slave terminals SLV1 to SLV5 and two priority-slave terminals SPV′1 and SPV′2.

The master terminal SPV3 pushes (“Push_packets”) the packets to a set of terminals comprising five slave terminals SLV1 to SLV5 and one priority-slave terminal SPV′1.

Within each swarm, the slave terminals SLV exchange what they have received via the protocol V2V.

Each master client SPV receives the packets of the content from the content server and other master clients with which it exchanges packets.

Each master client may wait a predefined time for a missing packet from the other master clients. If, at the end of this time, the requested packets are still missing, it may then request them from the content server CDN.

In one example, the bandwidth with which the master clients exchange the packets with one another or receive them from the content server is for example 60 Mb/s, and the content is split into packets of 1 M. There are for example 60 users of slave-client profile and three master clients that share the packets according to the protocol EB_SPV. Master clients will need to receive a chunk every 12 s to ensure smooth viewing. Hence, a master client will wait 4 s to receive the missing chunk from the other master clients, and, if it does not, it will download it directly from the content server CDN.

FIG. 4 shows the ability of two swarms to share a user, for example a slave client or a priority-slave client.

Thus, the priority-slave client SVP′1 of swarm S2 exchanges packets both with other clients of swarm S2 and with the clients of swarm S1, and the slave client SLV3 of swarm S3 exchanges packets both with other clients of swarm S3 and with those of swarm S2.

The shared client is chosen dynamically by the management server depending on the progress of the download of the content by each of the swarms. If, among two swarms, one of them has progressed more in its download, then a slave or priority-slave client of this swarm is shared with another swarm.

FIG. 4 also illustrates the possibility of a fourth profile being present on the network, namely that of ordinary user OV, which corresponds to a terminal having sufficient bandwidth to obtain the content from the content server CDN and to exchange with master clients SPV according to the EB_SPV protocol, but which are not connected to any slave clients SLV.

Thus, and in the case where the bandwidth is insufficient, master clients will be prioritized to receive packets from users OV the download of which has progressed and from the content server CDN, in order to allow them in turn to serve the slave clients that are connected thereto.

This operation results in some swarms progressing further than others. Slave clients forming part of more than one swarm will thus disseminate new chunks to swarms that are behind.

The invention is not limited to the example that has just been described. For example, the protocol V2V or EB SPV may make provision for a change in resolution or a switch to audio mode depending on the available bandwidth.

1. A method for distributing a content, from a content server in at least one private network comprising at least three terminals able to exchange data with one another, the bandwidth with which at least one terminal is able to connect to the content server being insufficient to allow the distribution of the content to each of the terminals via a connection of each thereof to the content server, the method comprising steps of:
a) listing, at least one of said terminals as master client and at least two other of said terminals as slave clients,
b) transmitting at least one portion of the content to be distributed to this master client,
c) bringing the master client to push at least one portion of the content to be distributed to at least one of the slave clients of the private network via the links existing between the terminals within the private network.

2. The method as claimed in claim 1, wherein for at least one slave client that has not received the required packets of the content to be distributed from the master client, this slave client receives missing packets from at least one other slave client using the links existing between the slave clients within the private network.

3. The method as claimed in claim 1, the content to be distributed between the slave clients being distributed via a peer-to-peer distribution mechanism.

4. The method as claimed in claim 1, comprising the step of listing at least one of said slave clients of the private network as priority-slave client, and bringing the master client to prioritize pushing the packets of the content to be distributed to this priority-slave client.

5. The method as claimed in claim 3, comprising the step of bringing the slave clients of the private network other than the priority-slave client to address themselves to the priority-slave client to receive the packets of the content to be distributed in case of failure of the master client.

6. The method as claimed in claim 1, comprising the step of listing as master client the first terminal of the private network to connect to the management server with a view to requesting reception of the content to be distributed.

7. The method as claimed in claim 1, comprising the step of listing as priority-slave client the second terminal of the private network to connect to the management server with a view to requesting reception of the content to be distributed.

8. The method as claimed in claim 1, comprising the step of determining, during a connection to the management server of a terminal of the private network, whether this terminal is able to access directly, because of the available bandwidth, the packets of the content to be distributed, and if so bringing this terminal to receive said packets from the content server directly or via a peer-to-peer connection with other terminals and not to receive pushed packets.

9. The method as claimed in claim 1, wherein the private network comprises between 3 and 10 000 terminals.

10. The method as claimed in claim 1, wherein the content to be distributed is a video content.

11. The method as claimed in claim 1, wherein at least one piece of information regarding the location of the terminals within the private network is listed in the management server and this piece of information is used to decide, for each terminal, the assignment of the addresses of the other terminals to be interrogated by this terminal to receive the packets of the content.

12. The method as claimed in claim 1, wherein at least one piece of information regarding the resources available to the terminals within the private network is listed in the management server and this piece of information is used to decide the assignment of a profile to a connecting terminal.

13. The method as claimed in claim 1, wherein at least one portion of the content to be distributed is pushed by the master client to randomly chosen slave clients of the private network.

14. The method as claimed in claim 1, wherein the management server transmits to a terminal of the private network information relating to the information-exchange protocol to implement with the other clients of the private network to retrieve the packets of the content to be distributed and/or to distribute them.

15. The method as claimed in claim 1, wherein the management server is dedicated to a plurality of separate private networks.

16. The method as claimed in claim 1, the management server being arranged to verify, during the connection of a terminal to the management server, whether this terminal has available to it resources that are greater than that of the master client with which it is intended to exchange to receive the packets of the content, and if so listing this terminal as new master client instead of the old one.

17. The method as claimed in claim 1, at least one slave client or one priority-slave client being shared between two swarms, the choice of the shared client being made by the management server.

18. The method as claimed in claim 1, the master client being arranged to wait a predefined time to receive a packet of the content from the other terminals, with which it is exchanging data, before contacting the content server to obtain this packet.

19. The method as claimed in claim 1, wherein in the presence of one or more terminals having a sufficient bandwidth to receive the packets directly from the content server and to exchange packets with at least one master client, but exchanging packets with no slave clients, the one or more master clients are arranged to prioritize seeking to receive the packets of the content from one or more of these terminals that have progressed most in the download of the content.

20. A computer-program product comprising, on a computer medium or a medium to be downloaded, a set of instructions that are readable by a management server, these instructions bringing during the execution of the program the management server to:
on reception of a request originating from a first terminal of at least one private network, a bandwidth with which this terminal is able to connect to a content server being sufficient to allow the content to be distributed to this first terminal via a direct connection thereof to the content server, list this terminal as master client,
bring this first terminal to push at least one portion of received packets of the content to be distributed, to at least one other terminal of the private network,
on reception of a request originating from another terminal of the private network, the bandwidth with which this other terminal is able to connect to the content server being insufficient to allow the content to be distributed to this other terminal, list this terminal as slave client and bring this terminal to receive the content to be distributed from the master client and/or from at least one other slave terminal of the private network via exchanges of data within the private network.
